(19) United States
(12) Patent Application Publication
(10) Pub. No.: US 2021/0262805 A1
(43) Pub. Date: Aug. 26, 2021

(54) INDOOR NAVIGATION METHOD AND PARKING MANAGEMENT SYSTEM

(71) Applicant: Continental Automotive GmbH, Hannover (DE)

(72) Inventor: Bin Ma, Shanghai (CN)

(21) Appl. No.: 17/271,886

(22) PCT Filed: Aug. 13, 2019
(86) PCT No.: PCT/EP2019/071767

§ 371 Date: Feb. 26, 2021

(30) Foreign Application Priority Data
Aug. 30, 2018 (CN) 201811006747.2

(51) Int. Cl. G01C 21/20; G16Y 10/75; G16Y 10/40; G01C 21/16

(52) U.S. Cl. CPC G01C 21/206; G01C 21/16; G16Y 10/40; G16Y 10/75

(57) ABSTRACT

An indoor navigation method, onboard device and car park management system, wherein the indoor navigation method comprises: a vehicle acquiring a reference path for driving in an indoor area to a first indoor position, the reference path being a path driven by a vehicle which first drove to the first indoor position; when using the first indoor position as an indoor navigation destination, a vehicle using inertial navigation technology, and during navigation, using the reference path to subject an actual inertial navigation path during this time to path deviation correction. By means of this method, a vehicle has no need to rely on additional positioning facilities and no need to obtain an indoor scenario map when driving indoors. Thus, this indoor navigation method is suitable for the vast majority of indoor navigation scenarios.

### BACKGROUND

### Technical Field

The present invention relates to navigation technology, in particular to an indoor navigation method and a parking management system.

### Background Art

At present, benefiting from the development of satellite positioning and navigation technology, people can rely on accurate satellite positioning and targeted navigation technology to reach destinations easily in outdoor environments. However, in some indoor scenarios, e.g. indoor car parks, due to the fact that satellite positioning signals are very weak, a vehicle cannot accurately locate its own position by means of satellite positioning, and the difficulty of navigating to indoor destinations is correspondingly increased.

In response to the abovementioned problem, the industry has provided many solutions, attempting to use technologies such as WiFi, Bluetooth and RFID to provide vehicle positioning in an indoor scenario, and then provide a driver with a navigation service by means of a map of the indoor scenario. However, all of the abovementioned solutions require the provision of additional communication facilities in the indoor scenario in order to provide communication with a vehicle, or require an associated positioning facility (e.g. using RFID as a road sign) to be arranged in the indoor scenario; these all require a large cost investment, and might also require the indoor environment to be modified to a certain extent. Moreover, a detailed map of the indoor scenario is indispensable, as stated above.

### BRIEF SUMMARY

The problem solved by the present invention is to provide an indoor navigation technology which does not need to rely on additional facilities and indoor scenario maps, in order to provide a low-cost indoor navigation service with a wider scope of suitability.

To solve the abovementioned problem, an indoor navigation method provided by the present invention comprises:

a vehicle acquiring a reference path for driving in an indoor area to a first indoor position, the reference path being a path driven by a vehicle which first drove to the first indoor position;

when using the first indoor position as an indoor navigation destination, a vehicle using inertial navigation technology, and during navigation, using the reference path to subject an actual inertial navigation path during this time to path deviation correction.

An onboard device suitable for indoor navigation provided by the present invention comprises: a communication module, an acquisition module and a navigation processing module; the acquisition module is used for obtaining instantaneous data acquired by an inertial sensor fitted to a vehicle; the navigation processing module records a path driven by the vehicle on the basis of the instantaneous data of the inertial sensor, and/or provides an inertial navigation service on the basis of the instantaneous data of the inertial sensor; and by means of the communication module, uploads the driven path to a remote server and/or acquires from the remote server a reference path for the vehicle to drive to an indoor navigation destination, and during navigation uses the reference path to subject an actual inertial navigation path during this time to path deviation correction.

A parking management system suitable for an indoor car park provided by the present invention comprises: a narrow-band Internet of Things device, disposed in the indoor car park and used to manage one or more parking spaces, each narrow-band Internet of Things device detecting an idle state of the managed one or more parking spaces; and a background management platform in communication with the narrow-band Internet of Things device;

the narrow-band Internet of Things device, when a vehicle drives into a parking space managed thereby for the first time, obtains from the vehicle a path by which it drove to the parking space after entering the indoor car park, and uploads same to the background management platform, to serve as a reference path for driving to the parking space; or the narrow-band Internet of Things device, when a vehicle drives into a parking space managed thereby for the first time, notifies the vehicle that the parking space has been driven into, and the vehicle uploads to the background management platform a path by which it drove to the parking space after entering the indoor car park, to serve as a reference path for driving to the parking space;

when entering the indoor car park, a vehicle equipped with an inertial navigation system obtains a reference path, provided by the background management platform, for driving to a parking space allocated to the vehicle, such that the vehicle, while driving to the allocated parking space, uses the reference path to subject an actual inertial navigation path during this time to path deviation correction.

Compared with the prior art, the solution described above has the following advantages:

By using a reference path as a reference standard for future indoor navigation, the indoor navigation method provided by the present invention enables a vehicle to use position points on the reference path as path reference positioning at any time during indoor driving, so as to correct position deviation of an actual inertial navigation path. By means of this method, a vehicle has no need to rely on additional positioning facilities and no need to obtain an indoor scenario map when driving indoors. Thus, this indoor navigation method is suitable for the vast majority of indoor navigation scenarios.

The onboard device provided by the present invention enables a vehicle to realize indoor navigation as described above by means of simple communication with a remote server (obtaining a reference path from the remote server), with no need for the vehicle to frequently communicate with a positioning device arranged in an indoor area as in the prior art.

With the parking management system suitable for an indoor car park that is provided by the present invention, when providing a navigation service in the car park, there is no need to further arrange a large number of positioning facilities in the car park or perform modification of the car park interior, and there is no need to provide a detailed map of the car park interior; this greatly reduces the maintenance cost and difficulty of the car park. Moreover, the state of parking spaces can be monitored in real time by means of a narrow-band Internet of Things device, and intelligent management of parking spaces can be realized by communication with a background management platform. On this basis, the background management platform can, based on the state of parking spaces, support the allocation of vehicle spaces in real time when vehicles enter/leave a car park or the remote reservation of parking spaces, as well as the abovementioned navigation service in the car park corresponding to parking spaces (issuing a reference path).

### BRIEF DESCRIPTION OF THE DRAWINGS

FIG. 1 is a schematic diagram of the principles of implementation of the indoor navigation method of the present invention in an indoor car park.

FIG. 2 is a structural schematic diagram of an embodiment of the onboard device of the present invention.

FIG. 3 is a schematic implementation diagram of an embodiment of the parking management system of the present invention.

FIG. 4 is a schematic implementation diagram of another embodiment of the parking management system of the present invention.

FIG. 5 is a schematic implementation diagram of another embodiment of the parking management system of the present invention.

FIG. 6 is a schematic implementation diagram of another embodiment of the parking management system of the present invention.

### DETAILED DESCRIPTION

In the following description, many specific details are expounded in order to give those skilled in the art a more comprehensive understanding of the present invention. However, it will be obvious to those skilled in the art that the implementation of the present invention may omit some of these specific details. Furthermore, it should be understood that the present invention is not limited to the specific embodiments presented. On the contrary, the use of any combination of the features and key elements below to implement the present invention may be considered, regardless of whether they relate to different embodiments. Furthermore, the aspects, features, embodiments and advantages below are merely explanatory, and should not be regarded as key elements or definitions of the claims, unless clearly stated in the claims.

As described in the background art section above, indoor navigation used for indoor car parks currently always needs to make use of infrastructure arranged in a car park in order to assist positioning. Moreover, the way in which the indoor navigation is performed is to provide a navigation service to a vehicle by means of a current position on a map obtained by positioning, therefore a car park operator is still required to provide a detailed map. Considering the accuracy of navigation, the provision of a highly precise detailed map also increases the operating cost for the car park operator. In view of this, the inventors of the present invention propose the use of inertial navigation technology, without any reliance on maps and positioning signals, to provide an indoor navigation service, and assist inertial navigation by means of a historical path by which it is possible to drive to a current indoor navigation destination.

Specifically, an indoor navigation method provided by the present invention comprises:

a vehicle acquiring a reference path for driving in an indoor area to a first indoor position, the reference path being a path driven by a vehicle which first drove to the first indoor position;

when using the first indoor position as an indoor navigation destination, a vehicle using inertial navigation technology to perform navigation, and during navigation, using the reference path to subject an actual inertial navigation path during this time to path deviation correction.

The first indoor position in the navigation method described above is a position which is located in an indoor area and will be set by a vehicle as an indoor navigation destination thereof on any occasion. For example, in the case of an indoor car park, the first indoor position may be a parking space, located in the indoor car park, where a vehicle wishes to park on any occasion. The design principle of the present invention as described above is that the navigation method uses the reference path to replace the map used previously, to serve as a standard for navigation of a vehicle to the first indoor position. In other words, once a first path for driving to the first indoor position (i.e. the abovementioned path by which the first indoor position was driven to for the first time) has been obtained, any subsequent vehicle can refer to this reference path during navigation when setting the first indoor position as an indoor navigation destination on this occasion.

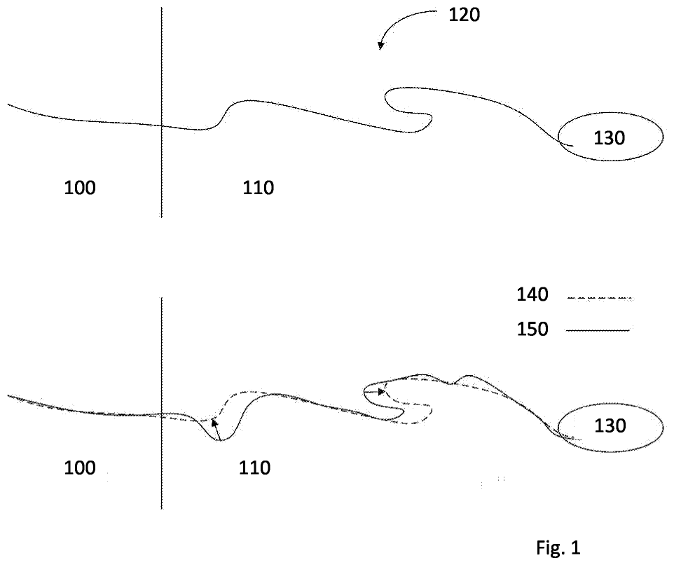

Referring to the schematic diagram of implementation of the present invention in an indoor car park as shown in FIG. 1, for a parking space no. xx, when a vehicle drives in an indoor area into the vehicle space for the first time, a path by which the vehicle drives in the indoor area to the vehicle space is identified as a reference path. When other subsequent vehicles also wish to be navigated to parking space no. xx, this reference path can be referred to during navigation. Specifically, in the process of navigating to parking space no. xx using the method of inertial navigation, if it is discovered that a current driving path of a vehicle (the solid-line path in the lower drawing in FIG. 1) deviates from the reference path (the dotted-line path in the lower drawing in FIG. 1), a reminder of this deviation may be issued by e.g. prompting the driver, and the driver may be guided to adjust the current driving path (as shown by the arrows in the lower drawing in FIG. 1) so that the current driving path conforms to the reference path. In this way, path deviation correction in the navigation of the subsequent vehicle to parking space no. xx is realized by means of the prompt and adjustment.

It can be seen therefrom that when navigating to a vehicle space in an indoor car park, the indoor navigation method of the present invention does not need to rely on facilities arranged in the car park (e.g. communication facilities such as WiFi or road sign facilities such as RFID in the prior art) in order to locate a vehicle's current position during navigation, and furthermore, does not need to be combined with positioning and a detailed map provided by the car park in order to issue navigation guidance. Throughout the process of navigation, it is only necessary to obtain the current driving path according to speed and position which inertial navigation itself needs to acquire, and navigation guidance can be realized by means of deviation correction based on the reference path. Clearly, from the perspective of the operator of an indoor car park, the indoor navigation method of the present invention does not require additional infrastructure cost investment, and does not require the provision of a precise map, so will not increase the operating cost of the indoor car park operator, and is suitable for various different indoor car parks. The abovementioned reference path can not only be obtained when placing a reservation for a parking space of an indoor car park, but can also be provided by a background management platform managing the indoor car park when entering the indoor car park. In view of the fact that many vehicles already have a vehicle networking function at the present time, it is very convenient for a vehicle to obtain the reference path by connecting to the internet in both of these situations, and there is no need to rely on internet communication facilities of the indoor car park.

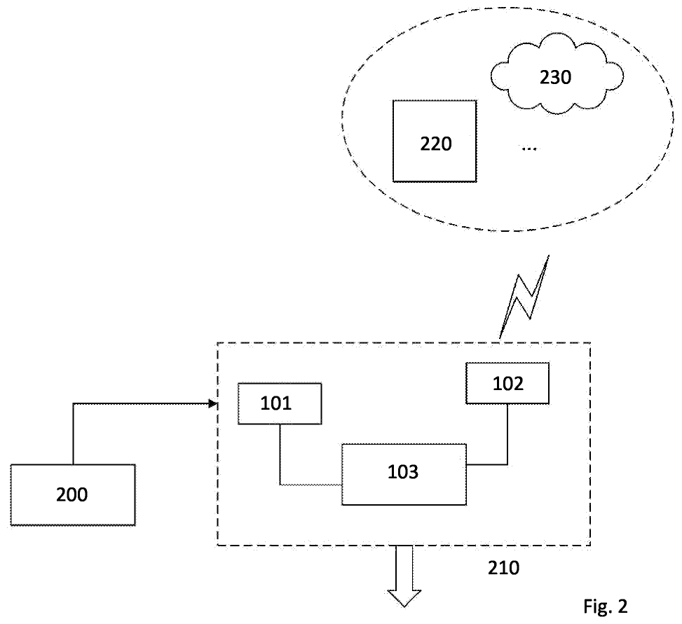

Corresponding to the indoor navigation method described above, FIG. 2 shows an embodiment of an onboard device suitable for indoor navigation according to the present invention. Referring to FIG. 2, the onboard device in this embodiment comprises: an acquisition module 101, a communication module 102 and a navigation processing module 103.

The acquisition module 101 may be connected to a bus network of a vehicle, in order to obtain from the bus network instantaneous data acquired by an inertial sensor 200 fitted to the vehicle. The inertial sensor 200 at least comprises: a gyroscope and an acceleration sensor. The gyroscope can measure rotational movement (angular movement) of the vehicle, and the acceleration sensor can measure translational movement (linear movement) of the vehicle; at the same time, vehicle wheel speed, angular speed and mileage information can also be acquired on the bus network, and an instantaneous speed and instantaneous position of the vehicle can be calculated by means of these instantaneous measurement data. Regarding the way in which the instantaneous speed and instantaneous position are obtained on the basis of the measurement data obtained on the gyroscope, acceleration sensor and bus network, this is prior art, so is not described again superfluously here.

Multiple instantaneous speeds and instantaneous positions calculated within a certain period of time form a driving path of the vehicle within this period of time, and this is also a data basis of inertial navigation. The navigation processing module 103 records a path driven by the vehicle on the basis of the instantaneous data of the inertial sensor, and/or provides an inertial navigation service on the basis of the instantaneous data of the inertial sensor; the navigation processing module 103 also uploads the driven path to a remote server (e.g. a background management platform of the indoor car park) by means of the communication module 102, and/or acquires from the remote server a reference path for the vehicle to drive to an indoor navigation destination. During navigation, the navigation processing module 103 uses the reference path to subject an actual inertial navigation path during this time to path deviation correction. In view of the fact that a gyroscope and acceleration sensor are essentially already standard equipment on vehicles at the present time, the onboard device of the present invention will not increase an additional hardware cost of the vehicle, in terms of the measurement data demand.

At the present time, many vehicles having a vehicle networking function are themselves already equipped with a vehicle networking terminal (Telematics Box/T Box, or a communication module implanted in another onboard device); the vehicle networking terminal has a bus network connected to the vehicle and has a communication function for networking. In the case of such a vehicle, the onboard device of the present invention can be formed by integrating, in the vehicle networking terminal, software capable of realizing the functions of the navigation processing module described above. In this way, apart from software integration, no additional hardware cost will arise, so the onboard device is suitable for large-scale popularization in vehicles equipped with vehicle networking terminals. Furthermore, the onboard device of the present invention also has general suitability for self-driving technology currently in development. In the case of self-driving vehicles, the abovementioned inertial sensor and vehicle networking terminal will be standard onboard hardware. Thus, the onboard device of the present invention is also perfectly usable in a scenario in which a self-driving vehicle drives automatically to a designated vehicle space in an indoor car park.

Based on the abovementioned design principles of the present invention, the present invention also provides a parking management system suitable for an indoor car park. The parking management system comprises: a narrow-band Internet of Things (NB-IOT) device, disposed in an indoor car park and used to manage one or more parking spaces, each NB-IOT device allocating unique vehicle space identification information to the one or more parking spaces managed thereby and detecting an idle state of the managed parking space; and a background management platform in communication with the NB-IOT device.

The NB-IOT device, when a vehicle drives into a parking space managed thereby for the first time, obtains from the vehicle a path by which it drove to the parking space after entering the indoor car park, and marks the path as a reference path for driving to the parking space and then uploads same to the background management platform; or the NB-IOB device, when a vehicle drives into a parking space managed thereby for the first time, notifies the vehicle that the parking space has been driven into, and the vehicle marks a path, by which it drove to the parking space after entering the indoor car park, as a reference path for driving to the parking space, and uploads same to the background management platform.

When entering the indoor car park, a vehicle equipped with an inertial navigation system (e.g. the abovementioned vehicle equipped with the onboard device of the present invention) obtains the reference path, provided by the background management platform, for driving to the parking space allocated to the vehicle, such that the vehicle, while driving to the allocated parking space, uses the reference path to subject an actual inertial navigation path during this time to path deviation correction.

As is well known, the NB-IOT device has advantages such as low power consumption, broad coverage, low cost and large capacity, and is generally used in application scenarios such as remote water meters/electricity meters and intelligent street lamps. It is also very suitable for application of the parking management system of the present invention, based on the design of the parking management system of the present invention. The broad coverage and large capacity of the NB-IOT device enables it to support the management of multiple parking spaces (although just one parking space can also be managed according to actual design needs, the management of multiple parking spaces is better able to embody the advantages of the NB-IOT device). In the case of large or ultra-large indoor car parks in particular (e.g. multi-story indoor car parks having several hundred parking spaces), the NB-IOT device can simultaneously process the idle state management of multiple parking spaces and communication with vehicles parking in multiple parking spaces. This also means that only a small number of NB-IOT devices are needed in order to realize the management of all parking spaces of a large indoor car park.

Correspondingly, since the cost of the NB-IOT device is very low, much lower than that of various communication facilities or parking space management terminals deployed in indoor car parks at the present time, the operator of an indoor car park (especially a large or ultra-large car park) can construct a parking management system at a very low cost. The low power consumption of the NB-IOT device (standby time can be as long as 10 years) also enables the maintenance cost of the operator to be reduced.

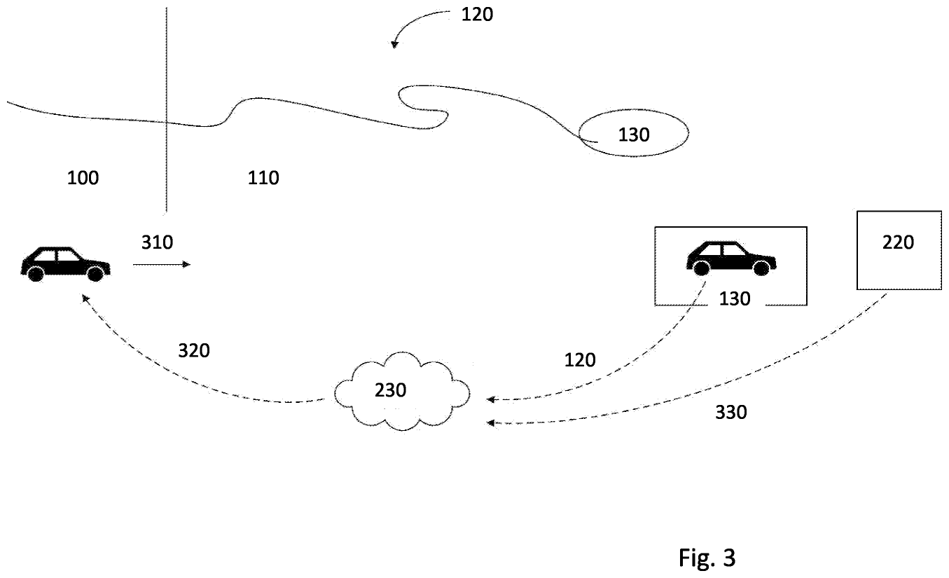

FIGS. 3-6 show multiple embodiments of the parking management system. Referring to FIG. 3 first of all, this shows the process of how to obtain a reference path for driving into a parking space no. xx. Before driving into this indoor car park, a vehicle can remotely place a reservation for a vehicle space via a background management platform; after receiving a reservation, the background management platform will notify the vehicle of a reserved vehicle space allocated thereto; alternatively, it is also possible to obtain a parking space allocated on the spot by the background management platform when driving into this indoor car park. When processing a reservation or before allocating a parking space on the spot, the background management platform will query each NB-IOT device in the car park about the idle state of the parking spaces managed thereby, and allocate a parking space with a “vacant” idle state to the current vehicle. Supposing that parking space no. xx is currently vacant, then the background management platform will allocate parking space no. xx to the current vehicle. For a parking space which it plans to allocate, the background management platform will also query whether it already has in storage a reference path for driving to the allocated parking space in the car park. Supposing that there is currently no reference path for driving to parking space no. xx, then when the vehicle drives into the car park, the background management platform will notify the vehicle that it is a vehicle which is driving into parking space no. xx for the first time, thereby triggering the vehicle to record a driving path by which the vehicle itself drives to parking space no. xx. In the case of a vehicle equipped with the onboard device of the present invention, referring to FIGS. 2 and 3, the background management platform transmits to the vehicle the abovementioned message about driving in for the first time; the navigation processing module 103 of the onboard device, after receiving the message via the communication module 102, begins recording the driving path thereof. Specifically, instantaneous data measured by the inertial sensor 200 is obtained by means of the acquisition module 101, and the instantaneous speed and instantaneous position thereof are obtained by calculation, in order to record the driving path thereof. After the vehicle has driven into parking space no. xx, the NB-IOT device managing parking space no. xx notifies the vehicle with a message that it has driven into the parking space, and after updating the idle state of parking space no. xx to “occupied”, reports to the background management platform. After obtaining the message notified by the NB-IOT device, the vehicle uploads a driving path thereof, beginning when the car park is driven into and ending at parking space no. xx, to the background management platform; the background management platform stores the uploaded driving path as a reference path for driving inside the car park to parking space no. xx.

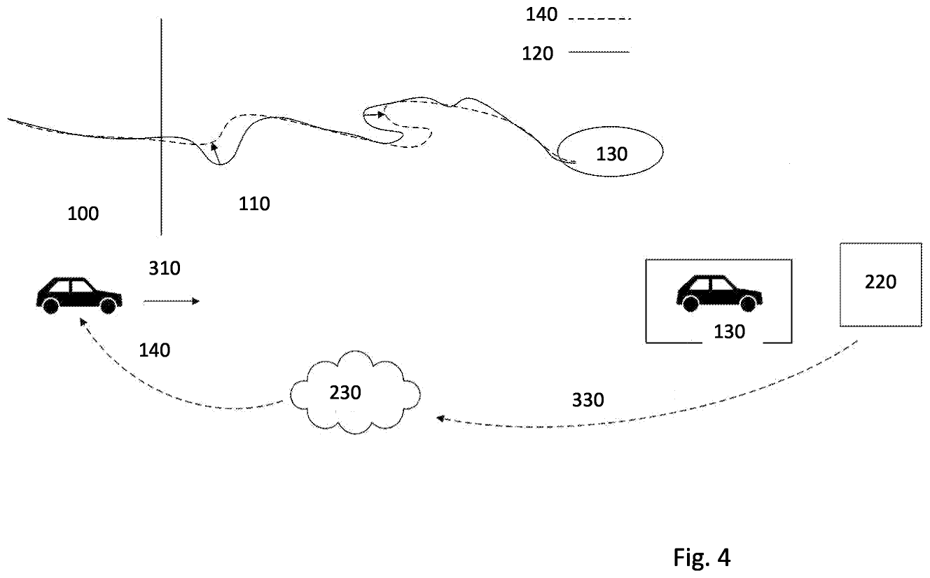

Continuing to refer to FIG. 4, when another subsequent vehicle has obtained parking space no. xx by reservation or on-the-spot allocation, the background management platform transmits to the vehicle the stored reference path for driving to parking space no. xx when the vehicle drives into the car park. In the case of a vehicle equipped with the onboard device of the present invention, referring to FIGS. 2 and 4, the background management platform transmits to the vehicle the reference path for driving to parking space no. xx; the navigation processing module 103 of the onboard device obtains the reference path via the communication module, and while obtaining instantaneous data measured by the inertial sensor 200 via the acquisition module 101 and thereby performing inertial navigation, uses the reference path to subject an actual inertial navigation path thereof to deviation correction, in order to guide the driver to drive into parking space no. xx. After the vehicle has driven into parking space no. xx, the NB-IOT device managing parking space no. xx updates the idle state of parking space no. xx to “occupied” and then reports to the background management platform.

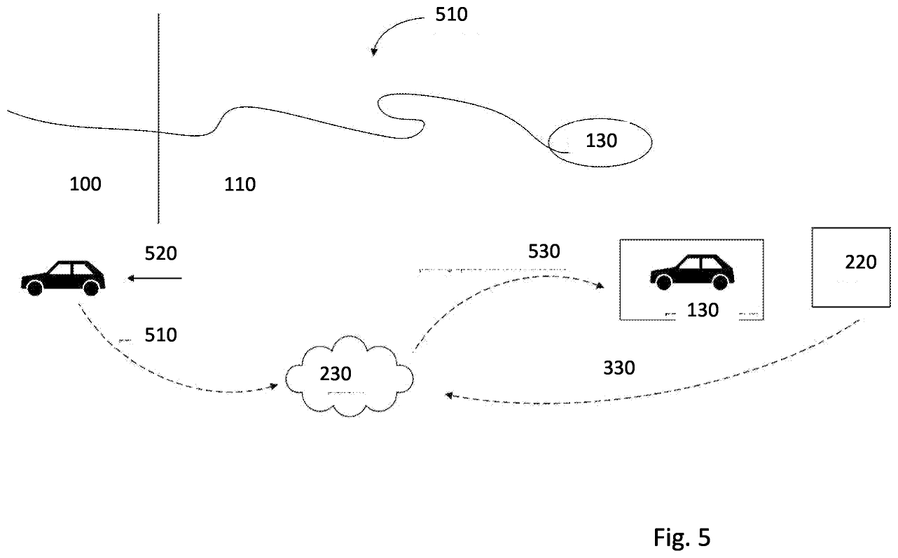

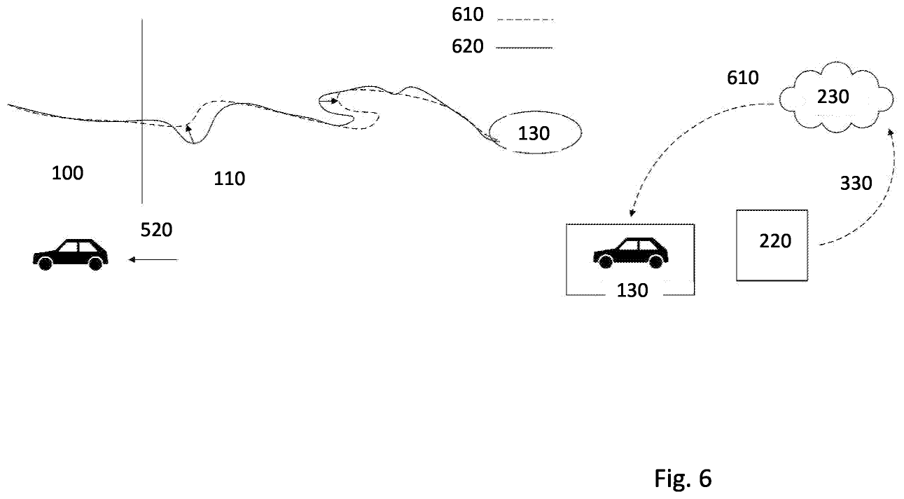

FIGS. 3 and 4 show application scenarios of driving into a parking space in an indoor car park; in view of the complex construction of indoor car parks at the present time, drivers also wish to know how to drive out of a car park from a parking space. FIGS. 5 and 6 correspondingly show implementations of scenarios in which the parking management system of the present invention solves the problem of driving out.

Correspondingly referring to the implementations shown in FIGS. 3 and 5, when a vehicle drives away from parking space no. xx, the background management platform learns of this information based on a change in the idle state (from “occupied” to “vacant”) of parking space no. xx reported by the NB-IOT device, and then queries whether it has in storage a reference path for driving out of the car park from parking space no. xx; if not, the background management platform will trigger the vehicle to record a driving path by which it drives out of the car park from parking space no. xx. In the case of a vehicle equipped with the onboard device of the present invention, referring to FIGS. 2 and 5, the background management platform transmits to the vehicle a message about driving out for the first time; the navigation processing module 103 of the onboard device, after receiving the message via the communication module 102, begins recording the driving path thereof. Specifically, instantaneous data measured by the inertial sensor 200 is obtained by means of the acquisition module 101, and the instantaneous speed and instantaneous position thereof are obtained by calculation, in order to record the driving path thereof. When the vehicle drives out of the car park, the navigation processing module 103 uploads the recorded driving path to the background management platform (it is not only possible to trigger uploading by means of a manual operation by the driver, but also possible to confirm that the vehicle has driven out of the car park according to a change in GPS position for example); the background management platform stores the uploaded driving path as a reference path for driving out of the car park from parking space no. xx.

Correspondingly referring to the implementations shown in FIGS. 4 and 6, when another subsequent vehicle has driven away from parking space no. xx, the background management platform learns of this information based on a change in the idle state (from “occupied” to “vacant”) of parking space no. xx reported by the NB-IOT device, and then transmits to the vehicle the reference path for driving out of the car park from parking space no. xx. In the case of a vehicle equipped with the onboard device of the present invention, referring to FIGS. 2 and 6, the background management platform transmits the reference path to the vehicle; the navigation processing module 103 of the onboard device obtains the reference path via the communication module, and while obtaining instantaneous data measured by the inertial sensor 200 via the acquisition module 101 and thereby performing inertial navigation, uses the reference path to subject an actual inertial navigation path thereof to deviation correction, in order to guide the driver to drive out of the car park.

Although the present invention has been disclosed above by way of preferred embodiments, the present invention is not limited thereto. Changes and amendments of all kinds made within the spirit and scope of the present invention by any person skilled in the art shall be included in the scope of protection of the present invention. Thus the scope of protection of the present invention shall be the scope defined by the claims.

1. An indoor navigation method, characterized by comprising:
a vehicle acquiring a reference path for driving in an indoor area to a first indoor position, the reference path being a path driven by a vehicle which first drove to the first indoor position;
when using the first indoor position as an indoor navigation destination, a vehicle using inertial navigation technology, and during navigation, using the reference path to subject an actual inertial navigation path during this time to path deviation correction.

2. The indoor navigation method as claimed in claim 1, characterized in that the inertial navigation technology is implemented by means of instantaneous data acquired by an inertial sensor fitted to a vehicle.

3. The indoor navigation method as claimed in claim 1, characterized in that the path driven by a vehicle which first drove to the first indoor position is uploaded to a server by means of an onboard communication device of the vehicle, and is marked and stored by the server as the reference path for driving to the first indoor position; the step of a vehicle acquiring the reference path for driving to the first indoor position comprises: a vehicle acquiring the reference path from the server.

4. The indoor navigation method as claimed in claim 3, characterized in that a vehicle acquires the reference path from the server by means of an onboard communication device.

5. The indoor navigation method as claimed in claim 4, characterized in that after confirmation of a navigation service request for driving to the first indoor position, a vehicle submits a reference path acquisition request to the server by means of an onboard communication device, and obtains, by means of the onboard communication device, the reference path provided by the server in response to the acquisition request.

6. The indoor navigation method as claimed in claim 3, characterized in that a vehicle acquires the reference path from the server when entering an indoor area.

7. An onboard device suitable for indoor navigation, characterized by comprising: a communication module, an acquisition module and a navigation processing module; the acquisition module is used for obtaining instantaneous data acquired by an inertial sensor fitted to a vehicle; the navigation processing module records a path driven by the vehicle on the basis of the instantaneous data of the inertial sensor, and/or provides an inertial navigation service on the basis of the instantaneous data of the inertial sensor; and by means of the communication module, uploads the driven path to a remote server and/or acquires from the remote server a reference path for the vehicle to drive to an indoor navigation destination, and during navigation uses the reference path to subject an actual inertial navigation path during this time to path deviation correction.

8. The onboard device as claimed in claim 7, characterized in that the inertial sensor at least comprises: a gyroscope and an acceleration sensor.

9. The onboard device as claimed in claim 7, characterized in that the communication module supports 3G, 4G or 5G communication.

10. The onboard device as claimed in claim 7, characterized in that the communication module supports communication with a narrow-band Internet of Things device; the indoor navigation destination is a parking space of an indoor car park, and the navigation processing module uploads the driven path to the remote server by means of the communication module on the basis of communication with the narrow-band Internet of Things device.

11. A parking management system suitable for an indoor car park, characterized by comprising: a narrow-band Internet of Things device, disposed in the indoor car park and used to manage one or more parking spaces, each narrow-band Internet of Things device detecting an idle state of the managed one or more parking spaces; and a background management platform in communication with the narrow-band Internet of Things device;
the narrow-band Internet of Things device, when a vehicle drives into a parking space managed thereby for the first time, obtains from the vehicle a path by which it drove to the parking space after entering the indoor car park, and uploads same to the background management platform, to serve as a reference path for driving to the parking space; or the narrow-band Internet of Things device, when a vehicle drives into a parking space managed thereby for the first time, notifies the vehicle that the parking space has been driven into, and the vehicle uploads to the background management platform a path by which it drove to the parking space after entering the indoor car park, to serve as a reference path for driving to the parking space;
when entering the indoor car park, a vehicle equipped with an inertial navigation system obtains a reference path, provided by the background management platform, for driving to a parking space allocated to the vehicle, such that the vehicle, while driving to the allocated parking space, uses the reference path to subject an actual inertial navigation path during this time to path deviation correction.

12. The parking management system as claimed in claim 11, characterized in that the background management platform allocates a parking space on the basis of a parking space idle state reported by the narrow-band Internet of Things device.

13. The parking management system as claimed in claim 11, characterized in that the background management platform allocates a parking space to a vehicle when the vehicle places a reservation with the background management platform for a parking space, or allocates a parking space to a vehicle when the vehicle enters the indoor car park.

14. The parking management system as claimed in claim 13, characterized in that the background management platform, when allocating the parking space to the vehicle, queries whether it already has in storage a reference path for driving to the parking space; and if not, when the vehicle enters the indoor car park, also triggers the vehicle to record a driving path by which it drives to the parking space.

15. The parking management system as claimed in claim 11, characterized by further comprising: the narrow-band Internet of Things device notifying the background management platform when a vehicle drives away from a parking space managed thereby, and the background management platform querying whether it already has in storage a reference path for driving out of the indoor car park from the parking space; and if not, triggering the vehicle to record a path by which it drives out of the indoor car park from the parking space; when the vehicle drives out of the indoor car park, the vehicle using the recorded path as a reference path for driving out of the indoor car park from the parking space, and uploading same to the background management platform.
